(19) United States
(12) Patent Application Publication
(10) Pub. No.: US 2026/0135077 A1
(43) Pub. Date: May 14, 2026

(54) Calender for Producing an Electrode Film from a Powder-Type Electrode Precursor Material, Corresponding Method and Corresponding Electrode Film

(71) Applicants: Matthews International GmbH, Vreden (DE); Matthews International Corporation, Pittsburgh, PA (US)

(72) Inventors: Harald BARTSCH, Dorsten (DE); Thomas HACKFORT, Ahaus-Altstätte (DE)

(21) Appl. No.: 18/705,722

(22) PCT Filed: May 12, 2022
(86) PCT No.: PCT/DE2022/100358

§ 371 Date: Apr. 29, 2024

Related U.S. Application Data
(60) Provisional application No. 63/275,857, filed on Nov. 4, 2021.

(51) Int. Cl. H01M 4/04

(52) U.S. Cl. CPC H01M 4/0435

(57) ABSTRACT

The invention relates to a calender for producing an electrode film from a powdered electrode precursor material, having at least a first and a second nip roll rotating in the opposite direction to the first, between which a nip is formed, wherein the calender is designed to subject the powdered electrode precursor material to shear forces as it passes through the nip and form an electrode film in this way, characterized in that at least one of the first or second nip rolls has at least one pretensioning device for pretensioning the nip roll against a non-axial, in particular radial and/or tangential force vector generated in the nip by the compression method, acting on the respective nip roll, by means of which the pretensioning direction and/or the magnitude of the pretensioning force can be adjusted. The invention furthermore relates to a method for producing an electrode film having a homogeneous thickness from a powdered electrode precursor material and a corresponding electrode film.

The invention is based on a calender for producing an electrode film from a powdered electrode precursor material, having at least one first and one second nip roll rotating in the opposite direction to the first, between which a nip is formed, wherein the calender is designed to subject the powdered electrode precursor material to shear forces as it passes through the nip and in this case to form an electrode film.

Electrodes can be used in electrical energy storage cells, which are widely used to power electronic, electromechanical, electrochemical, and other useful devices. Such cells include batteries such as primary chemical cells and secondary (rechargeable) cells, fuel cells, and various types of capacitors, including ultracapacitors. Electrodes can also be used in water treatment plants. Electric mobility in particular is clearly growing. The energy source in electrically powered vehicles, the battery, accounts for a large part of the costs. This is directly related to their production. This requires efficient and cost-effective production with a simultaneous increase in energy density. The calendering method is crucial for this purpose within the process chain for producing battery cells, such as lithium-ion battery cells.

The key components for the storage potential of an energy storage system are the electrodes. The electrochemical capabilities of electrodes, such as the capacity and efficiency of battery electrodes, are determined by various factors. These include the distribution of the active material, the binder, and the additives, the physical properties of the materials contained therein, such as particle size and surface area of the active material, the surface properties of the active materials and the physical properties of the electrode film, such as density, porosity, cohesion, and adhesion to a conductive element. Dry processing systems and methods traditionally use a processing step with high shear and/or high pressure to break up and mix the electrode film materials. Such systems and methods can contribute to structural advantages over wet-produced electrode films. However, the high processing pressures and large system dimensions (and thus the large space requirement) required for the production of dry, self-supporting electrode films and dry electrodes leave room for improvements.

A multi-roll calender for producing a dry electrode for an energy storage device is known from document US 2020/0 227 722A1. The system comprises a first feed system for dry electrode material, multiple calender rolls arranged in succession and a controller. The calender rolls are arranged so that they each form a gap between them. A first nip is provided to receive the dry electrode material from the first dry electrode material feed system and to form a dry electrode film from the dry electrode material.

The multi-roll calender known from the prior art has the disadvantage that the calender rolls can move laterally due to the forces acting in the nips and there are inaccuracies in the thickness of the electrode film to be produced or vibrations occur in the system. The problem increases the larger the roll widths and the smaller the roll diameters are selected to be. However, as demand for lithium-ion battery cells increases, it is necessary to use, among other things, rolls having larger widths and sometimes smaller diameters to increase system productivity and improve electrode quality. Therefore, there is a need for solutions that prevent the above-mentioned problems.

It is therefore the object of the present invention to improve a calendar in such a way that it enables higher process stability and is designed to produce a more uniform electrode film. The calender according to the invention therefore enables a simplified and more cost-effective method for producing electrodes.

The object is achieved with a device, a method, or an electrode film having the respective features of the independent claims.

Accordingly, it is provided that at least one of the first or second nip rolls has at least one pretensioning device for pretensioning the nip roll against a non-axial, in particular radial and/or tangential, force vector which is generated in the nip by the compression process and acts on the respective nip roll, by means of which the pretensioning direction and/or or the dimension of the pretensioning force is adjustable.

The calender according to the invention has, among other things, the advantage that an electrode web formed by the calender does not have to be self-supporting, since it can be positioned on and supported by a calender roll at least during some, if not all, process steps. For example, the electrode web can be supported by at least one calender roll during all process steps within a multi-roll calender system, including the lamination step when the electrode web is laminated on a metal foil to form an electrode.

An energy storage device produced with the aid of the calender according to the invention can have any suitable configuration, e.g., planar, spirally wound, button-shaped, toothed, or as a pouch. The energy storage device can be a component of a system, e.g., a power generation system, an uninterruptible power source system (UPS), a photovoltaic power generation system, an energy recovery system for use in, for example, industrial machinery and/or in transportation. The energy storage device can be used to power various electronic devices and/or motor vehicles, including hybrid electric vehicles (HEV), plug-in hybrid electric vehicles (PHEV), and/or electric vehicles (EV).

It can be provided that both nip rolls are each mounted in a machine frame via their front-side roll journals, wherein the pretensioning device is assigned to at least one bearing of the first or the second nip roll, wherein by means of the pretensioning device the roll journal can be deflected radially in any direction and in an adjustable order of magnitude relative to the at least one bearing. The nip rolls can each have a central calendering section which has a larger diameter than the roll journals. The nip can be formed between the calendering sections, so that the nip length can correspond to the length of the calendering sections. It can be provided that the powdered electrode precursor material is fed into the nip evenly over the nip length so that an electrode film having as homogeneous a thickness distribution as possible is created.

In particular, it can be provided that the pretensioning device has a double eccentric, wherein the double eccentric has an inner eccentric bushing and an outer eccentric bushing, which are pivotable independently of one another. The inner eccentric bushing can be accommodated in the outer eccentric bushing, at least in sections. An outer surface of the inner eccentric bushing can be opposite to an inner surface of the outer eccentric bushing. A clearance can be provided between the inner and outer eccentric bushings. The inner eccentric bushing can protrude from the outer eccentric bushing in sections. The outer eccentric bushing can have a section extending away from the inner eccentric bushing. The inner eccentric bushing can have an outside diameter which is smaller than the inside diameter of the outer eccentric bushing. The inner eccentric bushing can furthermore have an inner bore for receiving a roll journal. The inner bores of the inner and outer eccentric bushings can be arranged eccentrically in relation to the respective outer diameters. The eccentricities of the inner bushing and the outer eccentric bushing can be coordinated in such a way that, in a starting position, a roll journal received in the inner eccentric bushing is received or positioned centrally in the double eccentric. The calender can have a device for axially pivoting the inner eccentric bushing. The calender can furthermore have a device for axially pivoting the outer eccentric bushing. This allows the inner and outer eccentric bushings to be pivoted independently of each other. It can be provided that the order magnitude of the deflection can be adjusted by pivoting the inner and outer eccentric bushings relative to one another. Furthermore, it can be provided that the direction of the deflection is adjustable by means of pivoting both eccentric bushings together relative to the bearing journal. The double eccentric, in cooperation with the associated roll bearing, can cause the roll to bend. The roll bearing can be arranged further in the direction of the center of the roll, axially spaced apart from the double eccentric on the roll.

It is conceivable that the first or the second nip roll is rotatably mounted in the inner eccentric bushing. The respective roll journal can extend at least in sections into the pretensioning device or the inner eccentric bushing.

Furthermore, it can be provided that the outer eccentric bushing is rotatably mounted relative to a bore arranged in the machine frame, in which the pretensioning device is received. The bore can be introduced directly into the machine frame. Alternatively, the bore can be a cylinder liner inserted into the machine frame. A first radial bearing can be formed or arranged between the bore and the outer eccentric bushing.

It can also be provided that the inner eccentric bushing is rotatably mounted relative to the outer eccentric bushing. A second radial bearing can be formed or arranged between the outer eccentric bushing and the inner eccentric bushing.

Furthermore, a third radial bearing can be formed or arranged between the inner eccentric bushing and the roll journal. The first and/or the second and/or the third radial bearing can be designed as a cylindrical roll bearing or as a needle bearing.

In order to generate a sufficient pressing force in the nip and to provide a counter bearing for generating the pretensioning force, a first support roll can be arranged adjacent to the first nip roll and a second support roll can be arranged adjacent to the second nip roll, each of which rotates in opposite directions to the latter. In particular, it can be provided that the support rolls have a larger diameter than the first and second nip rolls. For example, the rolls can have a diameter of approximately 150-250 mm, preferably 200 mm, and the support rolls can have a diameter of 600-800 mm, preferably 700 mm. It can be provided that in a starting position of the double eccentric, the axes of the nip rolls and the support rolls are aligned with one another in one plane.

It can be provided that the first nip roll and the first support roll roll on one another and a nip is formed between the second nip roll and the second support roll for passing the electrode film through, wherein the second nip roll is designed to guide the electrode film around the upper or lower side of the second nip roll. In this case, direct contact can be provided between the first support roll and the first nip roll, so that the first nip roll can be supported on the first support roll. The second nip roll and the second support roll can be spaced apart from one another due to the nip provided. However, the second nip roll can be supported indirectly on the second support roll via the electrode film guided through the nip.

Above the nip between the first and second nip rolls, a device for continuously conveying powdered electrode precursor material into the nip can be arranged. The device can have a hopper for receiving the powdered electrode precursor material, which can extend over the entire nip width. The hopper can have a conveying gap on its lower side for the targeted conveying of the powder into the nip.

It can be provided that at least one of the first or second nip rolls has a pretensioning device on its opposite roll journals. However, it can also be provided that both the first and the second nip rolls each have a pretensioning device on their opposite roll journals. This means that both nip rolls can be pretensioned independently of one another or also against one another.

The invention furthermore relates to a method for producing an electrode film having a homogeneous thickness from a powdered electrode precursor material, comprising the following steps:
Conveying powdered electrode precursor material into a nip formed by two nip rolls;
Passing the powdered electrode precursor material through the nip, wherein the powdered electrode precursor material is subjected to shear forces as it passes through the nip, so that an electrode film is formed;
Applying a pre-tension to at least one of the two nip rolls in order to counteract a force vector resulting from the passing of the powdered electrode precursor material through the nip on the respective nip roll.

It can be provided that the application of a pre-tension comprises the radial deflection of at least one roll journal of the respective nip roll.

Furthermore, it can be provided that the radial deflection of the at least one roll journal comprises the relative and/or uniform pivoting of a double eccentric provided on the roll journal. The relative and/or uniform pivoting can in particular affect an inner and an outer eccentric bushing of the double eccentric.

It can be provided that the radial deflection comprises the deflection of two opposite roll journals of at least one of the nip rolls, wherein both roll journals are deflected radially in the same direction. The same direction can mean that both roll journals are deflected downwards, for example, or deflected horizontally towards one side of the roll axis in a top view of the roll axis.

Furthermore, it can be provided that the radial deflection comprises the deflection of two opposite roll journals of both of the nip rolls, wherein the opposite roll journals are each deflected in the same direction and the roll journals of the first and second nipping rolls are deflected in the same or in the diametrically opposite direction. For example, adjacent roll journals can both be deflected downwards or upwards, towards or away from one another.

The method can furthermore comprise: supporting each of the two nip rolls on the sides of the nip rolls facing away from the nip by means of a line force acting radially on each of the nip rolls. The line force can, for example, be transmitted via support rolls arranged adjacent to the two nip rolls.

The invention furthermore relates to an electrode film which has a homogeneous thickness so that the thickness variation of the electrode film across its width is not more than 10 μm, obtainable by passing a powdered electrode precursor material through a nip formed between a first and a second nip roll and in the course of this subjecting the powdered electrode precursor material to shear forces so that an electrode film is formed, in this case applying a pre-tension to at least one of the nip rolls in order to counteract a force vector resulting from the passing of the powdered electrode precursor material through the nip on the respective nip roll.

The electrode film can be one or more of an anode film, a cathode film, a separator film, a current collector film, an interlayer film, an adhesive film, a primer film, or a laminate made up of several of the above-mentioned films.

Further details of the invention are explained using the figures below. In the figures:

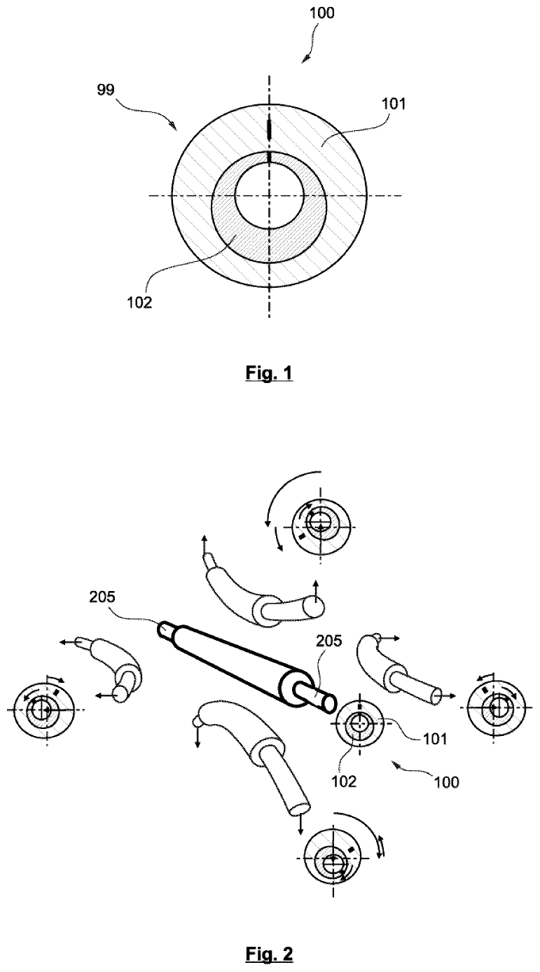

FIG. 1 shows a schematic view of a double eccentric for radially deflecting a bearing journal;

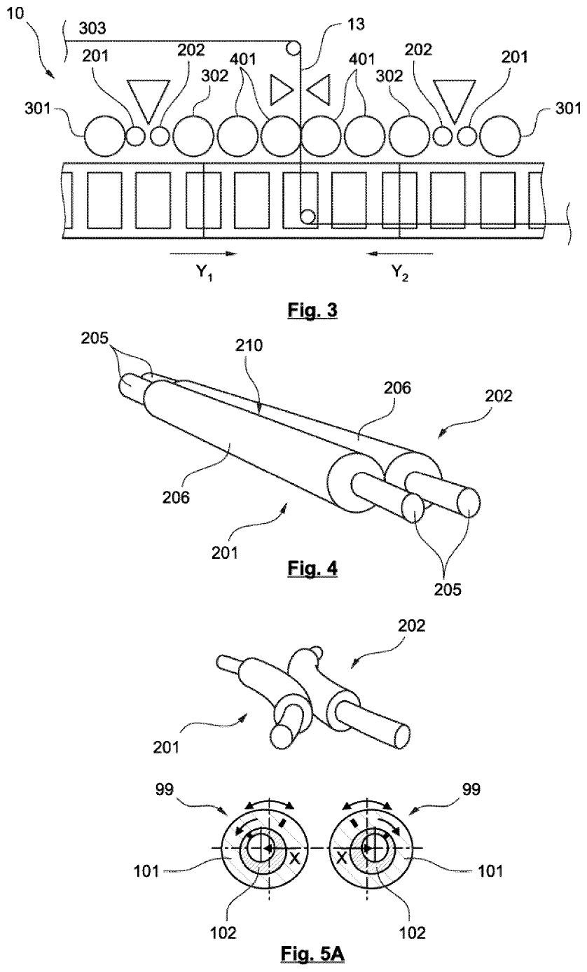

FIG. 2 shows a schematic view of a possible deflection of a roll caused by radial deflection of the roll journal of the roll;

FIG. 3 shows a side view of the installation situation of two calenders according to the invention arranged face to face;

FIG. 4 shows a perspective view of a roller alignment having no or prevented deflection;

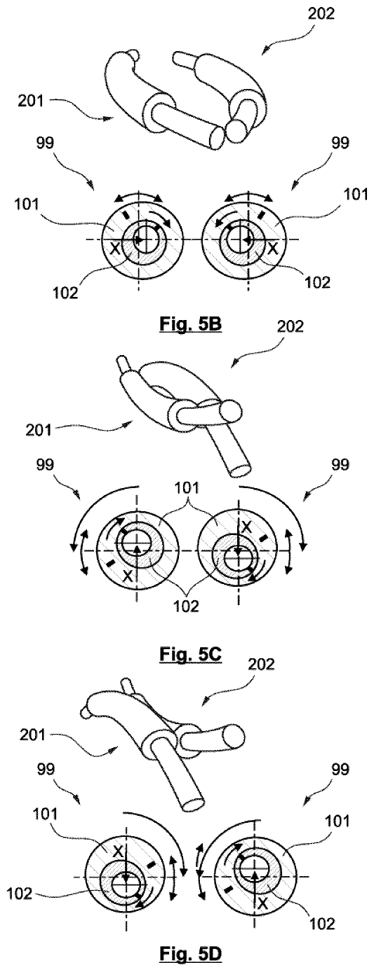

FIG. 5A shows an illustration of the interaction of the double eccentric with a resulting horizontally inward deflection of the calender rolls in the nip;

FIG. 5B shows an illustration of the interaction of the double eccentric with a resulting horizontally outward deflection of the calender rolls in the nip;

FIG. 5C shows an illustration of the interaction of the double eccentric with a resulting opposite vertical deflection of the calender rolls in the nip;

FIG. 5D shows an illustration of the interaction of the double eccentric with a resulting opposite vertical deflection of the calender rolls in the nip;

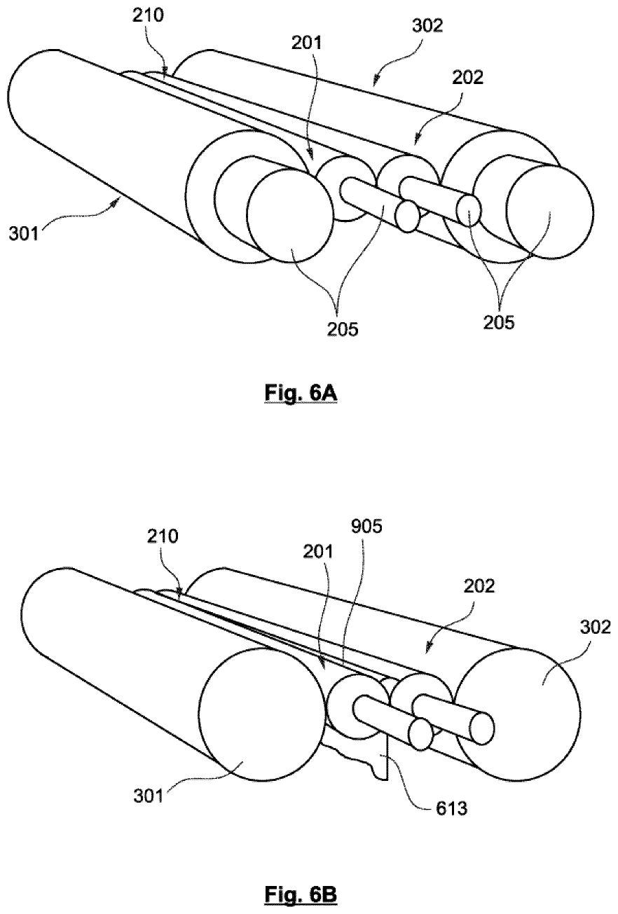

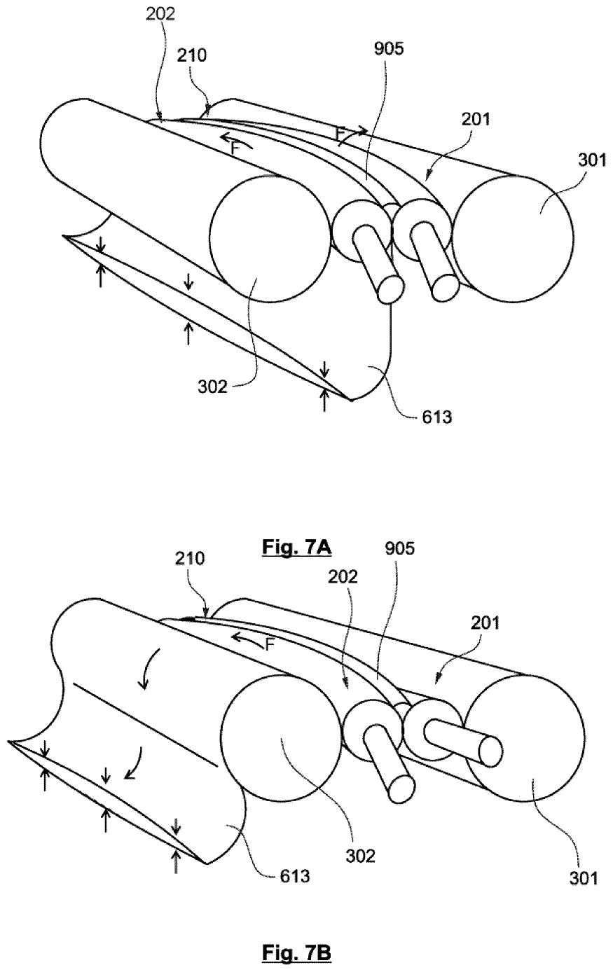

FIG. 6A shows a perspective view of the calender rolls in conjunction with adjacent support rolls;

FIG. 6B shows a perspective view of the calender rolls in combination with adjacent support rolls as well as powdered electrode precursor material conveyed into the nip or an electrode film formed after the nip;

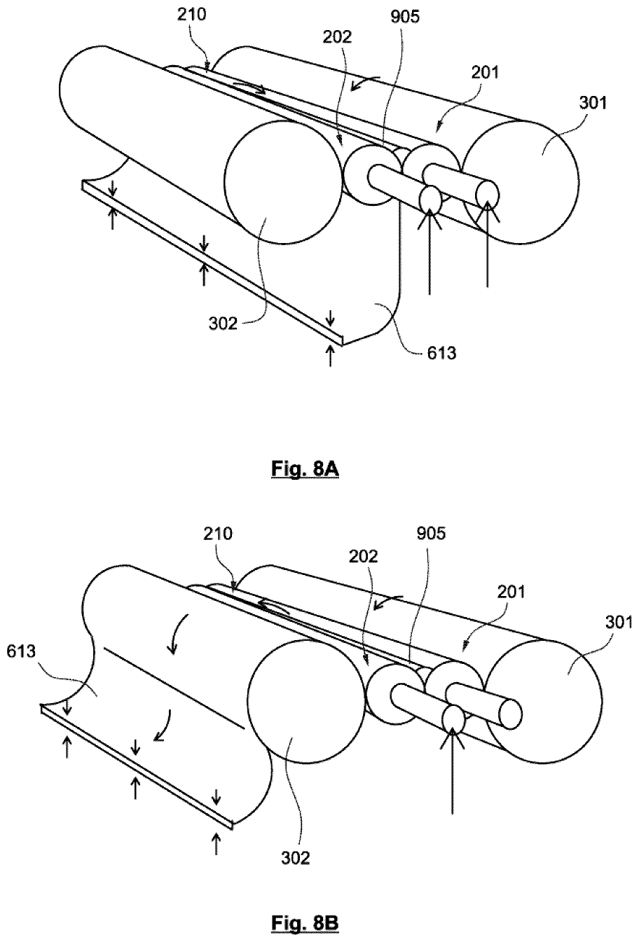

FIG. 7A shows a perspective view of the calender rolls in conjunction with adjacent support rolls, wherein both calender rolls have an evasive bend induced by the compacting process, due to which the electrode film has an inhomogeneous thickness distribution;

FIG. 7B shows a perspective view of the calender rolls in conjunction with adjacent support rolls, wherein one of the calender rolls has an evasive bend induced by the compacting process, due to which the electrode film has an inhomogeneous thickness distribution;

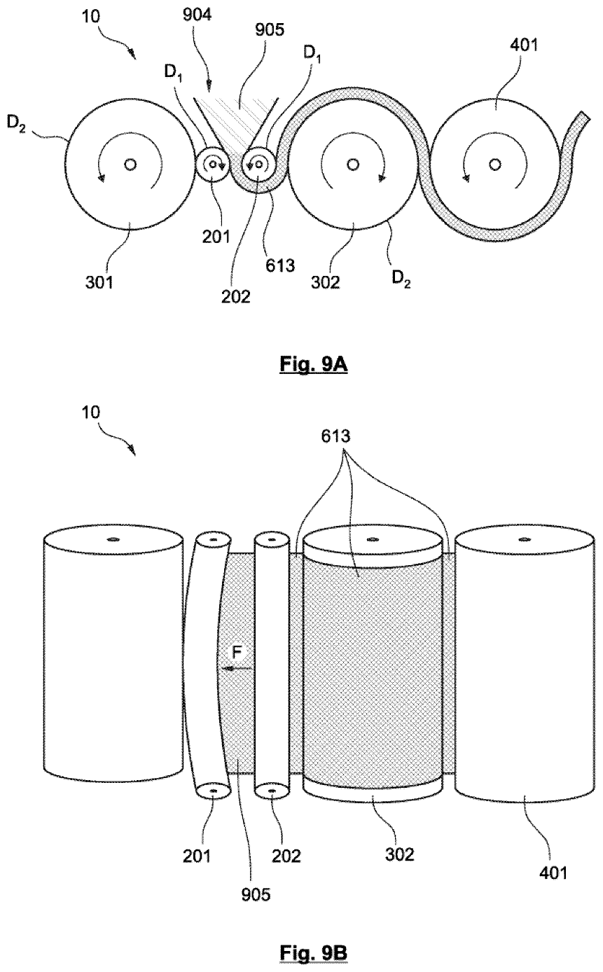

FIG. 8A shows a perspective view of the calender rolls in conjunction with adjacent support rolls, wherein the electrode film has a homogeneous thickness distribution due to correct calender roll alignment;

FIG. 8B shows a perspective view of the calender rolls in conjunction with adjacent support rolls, wherein the electrode film has a homogeneous thickness distribution due to correct calender roll alignment, wherein the electrode film is guided around one of the support rolls;

FIG. 9A shows an exemplary side view of the process of electrode film production in the calender according to the invention;

FIG. 9B shows an exemplary top view of the process of electrode film production in the calender according to the invention;

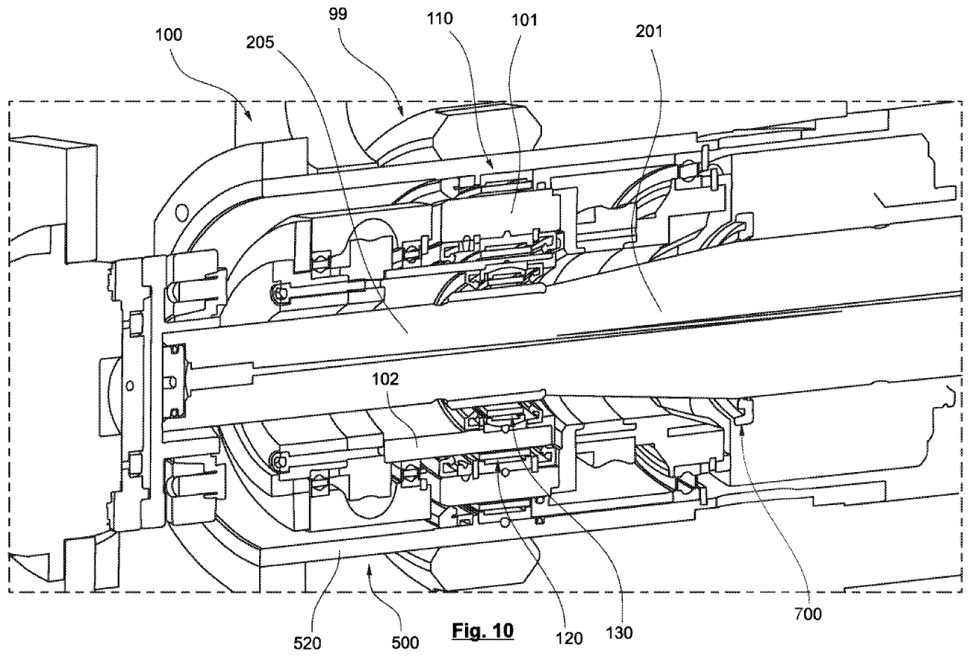

FIG. 10 shows a perspective view of a roll journal mounted in a pretensioning device according to the invention.

FIG. 1 shows an exemplary double eccentric 99, which is used to deflect a roll journal 205 at any angle orthogonal to the center axis of the respective nip roll 201, 202 and in an adjustable order of magnitude. The double eccentric 99 has an outer eccentric bushing 101, the inner bore of which is eccentric with respect to the outer diameter. The double eccentric 99 also has an inner eccentric bushing 102, the inner bore of which is concentric to the outer diameter of the outer eccentric bushing in a starting position. The double eccentric 99 is configured in such a way that it exerts a deflection on the nip roll 201, 202 by deflection of the roll journal 205 having the pretensioning device 100, so that a deflection of the nip roll can be counteracted by a force vector F generated in the nip by the electrode powder. The inner and outer eccentric bushings 102, 103 are pivotable relative to one another or in the same direction, so that the eccentricity of the inner bore of the inner eccentric bushing is adjustable, wherein the direction and degree of deflection are variable. Each of the eccentric bushings 102, 102 has a thick section and a thin section opposite to the thick section. In the starting position described above, the thick section of the outer eccentric bushing 101 and the thin section of the inner eccentric bushing 102 are proximate, and the thin section of the outer eccentric bushing 101 and the thick section of the inner eccentric bushing 102 are proximate. When both eccentric bushings 101, 102 are pivoted relative to one another by 180°, the greatest possible off-center deflection can be achieved.

FIG. 2 illustrates the possible deflection of a nip roll 201 having a pretensioning device 100 on each of the two opposite roll journals 205, which can be achieved by rotating the eccentric bushings 101, 102 with respect to their starting position. This includes the representation of the rotation of the eccentric bushings 101, 102, which results in a deflection of the roll journals 205 vertically downwards, the rotation of the eccentric bushings 101, 102, which results in a deflection of the roll journals 205 horizontally to the left, the rotation of the eccentric bushings 101, 102, which results in a deflection of the roll journals 205 vertically upwards, and the rotation of the eccentric bushings 101, 102, which results in a deflection of the roll journals 205 horizontally to the right. The corresponding pivot direction of the inner eccentric bushing and the outer eccentric bushing is shown in each case. For example, to deflect the roll journal 205 vertically upwards, the outer eccentric bushing 101 together with the inner eccentric bushing 102 is first pivoted by approximately 120° counterclockwise as shown and the inner eccentric bushing 102 is then pivoted back relative to the outer eccentric bushing 101 by approximately 90° clockwise. The further deflection positions are set in a corresponding manner, as illustrated in each case by the arrow directions shown.

FIG. 3 shows a side view of a calender 10, which shows the arrangement of the rolls 201, 202 with respect to the support rolls 301, 302 in the integrated rolling system according to an embodiment. The calender 10 is used to produce a separator film 303 coated on both sides with electrode films 613. The arrangement 2 has two calender arrangements positioned frontally side by side, which have opposite main conveying directions Y1, Y2. The calender arrangements each have six rolls 301, 201, 202, 302, 401, wherein in each case the input-side end roll 301 is designed as a support roll 301 rolling directly on the first nip roll 201 and the output-side end rolls form a common end nip 13. A separator film 303 is fed vertically from above to the end nip 13, which is coated on both sides by means of the electrode films 613 produced in the two calender arrangements, so that the coated separator film 303 leaves the end nip 13 vertically downwards and can then be cut to length and/or rolled up or further processed.

FIG. 4 shows the alignment of the nip rolls 201, 202 without deflection, so that one or more pretensioning devices 100 provided on the nip rolls 201, 202 are in their starting position. This alignment comprises a nip roll 201 positioned adjacent and parallel to a second nip roll 202.

FIGS. 5A-5D show the interaction of the inner and outer eccentric bushings 102, 202 on the nip rolls 201, 202 in aligning the deflection of the nip rolls against a force vector F acting in the nip 210. FIG. 5A shows a nip roll 201 in alignment with a second nip roll 202, wherein the eccentric bushings 102, 102 of the first nip roll 201 are aligned such that they generate a deflection of the roll journals 205 horizontally to the left and thus a roll deflection horizontally to the right, and the eccentric bushings 102, 102 of the second nip roll 202 are aligned such that they generate a deflection of the roll journals 205 horizontally to the right and thus a roll deflection horizontally to the left. FIG. 5B shows a nip roll 201 in alignment with a second nip roll 202, wherein the eccentric bushings 102, 102 of the first nip roll 201 are aligned such that they generate a deflection of the roll journals 205 horizontally to the right and thus a roll deflection horizontally to the left, and the eccentric bushings 102, 102 of the second nip roll 202 are aligned such that they generate a deflection of the roll journal 205 horizontally to the left and thus a roll deflection horizontally to the right. FIG. 5C shows a nip roll 201 in alignment with a second nip roll 202, wherein the eccentric bushings 102, 102 of the first nip roll 201 are aligned such that they generate a deflection of the roll journals 205 vertically upward and thus a roll deflection vertically downward, and the eccentric bushings 102, 102 of the second nip roll 202 are aligned such that they generate a deflection of the roll journal 205 vertically downward and thus a roll deflection vertically upward. FIG. 5D shows a nip roll 201 in alignment with a second nip roll 202, wherein the eccentric bushings 102, 102 of the first nip roll 201 are aligned such that they produce a deflection of the roll journals 205 vertically downward and thus a roll deflection vertically upward, and the eccentric bushings 102, 102 of the second nip roll 202 are aligned such that they produce a deflection of the roll journal 205 vertically upward and thus a roll deflection vertically downward.

FIGS. 6A-6B show the alignment of the nip rolls 201, 202 with the support rolls 301, 302 and the use of the rolls to produce an electrode film 613. This includes an arrangement of adjacent rolls including, from left to right, a first support roll 301, a first nip roll 201, a second nip roll 202 and a second support roll 302, all aligned with one another. The powdered electrode precursor material 905 is fed from above into a nip 210 between the two nip rolls 201, 202 and formed therein into an electrode film 613, which leaves the nip 210 at the lower side of the nip rolls 201, 202.

FIGS. 7A-7B show the impermissible thickness tolerance that arises from the deflection of the nip rolls 201, 202 when they are not pretensioned by the pretensioning device 100 according to the invention. Due to the pressing forces in the nip 210 resulting from the conveying of the electrode powder 905 through the nip 210, the nip rolls 201, 202 experience an upward deflection or they evade the pressing forces. This results in the production of an electrode film 613 having an impermissible thickness tolerance, wherein the thickness of the film can increase in particular towards the center. As shown in FIG. 7B, the evasion behavior of the nip rolls 201, 202 can also take place asymmetrically, so that only one of the nip rolls 201, 202 is deflected or they are deflected to different degrees. In the example shown, only the second nip roll 202 deflects upwards, while the first nip roll 201 does not experience any deflection. This is because there is higher friction between the first nip roll 201 and the first support roll 301 due to direct contact, while the friction between the second nip roll 202 and the electrode film 613 is lower.

FIGS. 8A-8B show an electrode film 613 having a uniform layer thickness produced by correctly aligned nip rolls 201, 202 according to one embodiment. By correctly adjusted pretensioning devices 100, the two nip rolls 201, 202 are correctly aligned so that there is no net deflection or the process and pretensioning forces present in the nip balance each other out, which results in the production of a film 613 having a homogeneous thickness distribution. FIG. 8B illustrates the further transport of the electrode film 613, which is guided in a meandering manner around the rolls in a main conveying direction.

During operation, the nip rolls 201, 202 are deflected to adjust the film 613 that forms as the dry powder mixture 905 is passed through the nip 210. In some embodiments, the deflection of the roll journals 205 is approximately 5 μm, approximately 10 μm, approximately 15 μm, approximately 20 μm, approximately 25 μm, approximately 30 μm, approximately 35 μm, approximately 40 μm, approximately 45 μm, approximately 50 μm, approximately 55 μm, approximately 60 μm, approximately 65 μm, approximately 70 μm, approximately 75 μm, approximately 80 μm, approximately 85 μm, approximately 90 μm, approximately 95 μm or approximately 100 μm, in each case based on a roll having a diameter of approximately 200 mm. Alternatively, the size of the deflection can be expressed as a ratio chosen based on the overall dimension of the pressure roll. In one embodiment, the deflection ratio is approximately 2.5×10⁻⁵ to approximately 0.0005, approximately 5×10⁻⁵ to approximately 0.0005, or approximately 7.5×10⁻⁵ to approximately 0.0005, based on the amount of deflection of the roll divided by the roll diameter. Although the above values are indicated on the basis of a nip roll having a diameter of 200 mm, the diameter of the roller is not thus limited.

In addition to the amount and direction of roll deflection, the nip rolls 201, 202 can be controlled individually by rotating only the eccentric bushings which are connected to each individual roll. This allows the user to further control the distance between the rolls and thus the thickness of the film that passes between the rolls. The direction of rotation is not limited and each of the eccentric bushings 101, 102 can be rotated separately by any amount. Additionally, each individual eccentric bearing connected to a specific nip roll can be adjusted, allowing additional control over the deflection of each roll.

In some embodiments, the nip rolls 201, 202 have a crown that is used to further increase the accuracy and precision that the rolls exert on an electrode film 613. Crowning ensures that the contact surface, and therefore the film profile and thickness, remains flat and accurate when the roll is deflected or otherwise manipulated. The height of the crown is not limited and is selected depending on the requirements of a particular film and the deflection chosen for each roll. In some embodiments, the pressure roller has a crown of approximately 3 μm, approximately 4 μm, approximately 5 μm, approximately 6 μm, approximately 7 μm, approximately 8 μm, approximately 9 μm, approximately 10 μm, or any range of the above values, such as 3 μm to approximately 10 μm, approximately 4 μm to approximately 9 μm or approximately 4 μm to approximately 8 μm.

The film 613 formed by the nip rolls 201, 202 is not limited and can be a metal, a polymer, a paper, a ceramic, or a blend or laminate of one or more of the above. In certain embodiments, the film is formed from a dry powder which is then molded as part of a lithium-ion cell. When the film is formed from a dry powder, it is shaped into a cathode or an anode for building battery cells.

In addition to adjusting the nip 210 between the nip rolls 201, 202 to control the film thickness, the nip rolls 201, 202 and the pretensioning devices 100 can also be used to adjust the pressure exerted on the film. The magnitude of the force applied by the first nip roll 201 or the second nip roll 202, which is solely due to the adjustments made by the eccentric bearings, can, without any external structures or devices, be up to approximately 75 kN, up to approximately 50 kN, up to approximately 25 KN, approximately 1 kN to approximately 75 kN, approximately 1 kN to approximately 50 kN, approximately 10 KN to approximately 50 kN, approximately 10 kN to approximately 40 kN, approximately 10 KN to approximately 30 kN, or any combination of one or more of the above-mentioned ranges. In this way, the first nip roll 201 and the second nip roll 202 can each be adjusted independently and exert significant pressure on a powder or film. It is assumed that the above-mentioned pressure is due only to the adjustments made by the double eccentrics 99 and that the first nip 210 and the second nip 210 may each exert additional force based on other structures in the device.

Alternatively, the accuracy of the double eccentric 99 and the associated nip roll 201, 202 is measured by the uniformity of the film 613 formed by the nip roll 201, 202. In some embodiments, a cathode or anode film formed by the nip roll 201, 202 has a measured thickness that varies by no more than approximately 10 μm, no more than approximately 8 μm, no more than approximately 6 μm, no more than approximately 4 μm, no more than approximately 3 μm, no more than approximately 2 μm, no more than approximately 1 μm, approximately 1-10 μm, approximately 1-8 μm, approximately 1-6 μm, approximately 1-4 μm, approximately 1-3 μm, or approximately 1-2 μm. The above values are measured across the width of the film required for the form factor of the battery cell being produced.

For each of the above paragraphs describing the crown of the nip roll, the force applied to the nip rolls and the accuracy of the eccentric bearing and associated nip rolls as measured by the uniformity of the film, these values are in turn measured in relation to the width required for the form factor of the cells, such as lithium-ion cells, to be produced using the device. Examples of form factors are not limited and comprise cylindrical cells 10440 or 1044 (10 mm diameter and 44 mm length), 14500 or 1450 (14 mm diameter and 50 mm length), 16340 or 1634 or CR123A (16 mm diameter and 34 mm length), 18650 or 1865 (18 mm diameter by 65 mm length), 21700 or 2170 (21 mm diameter by 70 mm length), 26650 or 2665 (26 mm diameter by 65 mm length), 32650 or 3265 (32 mm diameter by 65 mm length), and 4680 (46 mm diameter by 80 mm length). Prismatic and pouch cells are also conceivable, wherein there is no limit to the dimensions considered.

The disclosed device can furthermore comprise one or more position sensors connected to the eccentric bearings 99, the nip rolls 201, 202, or both. The position sensors determine the amount of rotation of the eccentric bearings or the amount of rotation of the nip rolls and supply a digital or analog signal corresponding to that amount of rotation of the nip rolls or the eccentric bearings. Such position sensors are not limited and comprise potentiometric sensors, capacitive position sensors, or optical position sensors. The optical position sensors can work with any light, including ultraviolet (UV), visible, or infrared light. In certain embodiments, the light selected for the optical position sensor is a laser having one of the above-mentioned bandwidths.

In still other embodiments or in conjunction with the provided position sensors, one or more layer thickness sensors can also be provided. The film thickness sensors are not limited and comprise optical sensors such as laser sensors. The film thickness sensors determine the thickness of the film formed by the pressure rolls by measuring the film thickness at at least one point on the film. In some embodiments, there are one or more film thickness sensors configured to measure thickness at multiple points across the width of the film. The thickness sensors supply a digital or analog signal that corresponds to the thickness of the film.

The use of the nip rolls 201, 202 and associated components of the disclosure is not limited, but certain uses are desirable. In some embodiments, production lines are constructed that include the nip rolls of the disclosure together with various other components known to those skilled in the art. The nip rolls are used to precisely control the thickness of the films produced in the entire production line. Examples of the films configured to be formed or using the nip rolls and associated components of the disclosure comprise one or more anode films, cathode films, separator films, current collector films, interlayer films, adhesive films, primer films, or laminates comprising two or more of the films described above.

The disclosed nip rolls 201, 202 and associated components are disclosed as being useful for forming films from a powder, but there are other applications as well. For example, it is conceivable that the nip rolls and associated components can form films of liquids or non-Newtonian fluids such as slurries.

FIGS. 9A and 9B show an illustration of a particularly advantageous embodiment of the disclosure. According to FIGS. 9A and 9B, a calender 10 comprises a first nip roll 201 and a second nip roll 202 arranged in direct proximity to a powder hopper 904 for receiving powdered electrode material 905. Furthermore, a first support roll 301 and a second support roll 302 are arranged on one side of the first nip roll 201 and the second nip roll 202. In use, the electrode material 905, which is typically a powder for a dry electrode, is compressed by the first nip roll 201 and the second nip roll 202, by which a dry electrode film 613 is formed. After passing through and being deformed by the pressure exerted by the first nip roll 201 and the second nip roll 202, the dry electrode film 613 winds around the first calender roll 302 and the second calender roll 401. During the movement of the dry electrode film 613, it is compressed and exerts an equal and opposite force on the first pressure roller 201 and the second pressure roller 202. However, the first nip roll 201 and the second nip roll 202 are subjected to different forces due to friction differences. In the example shown, the first nip roll 201 thus undergoes a deflection and has to be pre-tensioned accordingly by the pretensioning device 100 (not shown). The second nip roll 202 is surrounded by the dry electrode 613 and, as shown, has no deflection. The second nip roll 202 therefore does not need to be adjusted to the extent required for the first nip roll 201.

Therefore, in the document described here and in FIG. 9B, the first nip roll 201 and the second nip roll 202 are adjusted by one or more pre-tensioning devices 100 so that the magnitude of the adjusting force that is exerted on the first nip roll 201 is greater than the magnitude of the adjusting force that is exerted on the second nip roll 202. Accordingly, a uniform and precisely controlled gap between the first nip roll 201 and the second nip roll 202 is ensured as the dry electrode film 613 passes through.

FIG. 10 shows a sectional view through a nip roll 201 and a pretensioning device 100 mounted on the roll journal 205 of the nip roll 201. The roller 201 is mounted in a machine frame 500 by means of a roll bearing 700. The machine frame furthermore has a bore 520 with a cylinder bushing received therein on the front side of the roller 201, 202, in which the roll journal 205 of the nip roll 201, 202 is received and mounted in the pretensioning device 100. The pretensioning device 100 comprises a double eccentric 99, which essentially consists of an inner eccentric bushing 102 and an outer eccentric bushing 101. The inner eccentric bushing 102 is inserted into the outer eccentric bushing 101 so that they overlap in sections. The outer eccentric bushing 101 is mounted axially rotatably relative to the cylinder bushing via a first radial bearing 110. The inner eccentric bushing 102 is mounted relative to the outer eccentric bushing 101 via a second axially rotatable radial bearing 120. The roll journal 205 is in turn mounted axially rotatable relative to the inner eccentric bushing 102 via a third radial bearing 130. In the orientation shown, the double eccentric 99 is in its starting position, in which the thick section of the outer eccentric bushing is proximate to the thin section of the inner eccentric bushing 102 and the thin section of the outer eccentric bushing 101 is proximate to the thick section of the inner eccentric bushing 102 so that the roll journal is centered and not deflected. The eccentric bushings 101 and 102 are adjustable independently of each other by means of separate pivoting devices. To produce a defined roll bend in the roll center, the double eccentric 99 having the roll journal 205 accommodated therein is deflected relative to the roll bearing 700 so that the distance between the double eccentric 99 and the roll bearing 700 functions as a lever arm.

The features of the invention disclosed in the above description, in the figures and in the claims can be essential for the implementation of the invention both individually and in any combination.

### LIST OF REFERENCE NUMERALS

10 calender
99 double eccentric
101 outer eccentric bushing
102 inner eccentric bushing
110 first radial bearing
120 second radial bearing
130 third radial bearing
201 first nip roll
202 second nip roll
205 roll journal
206 calendering section
210 nip
301 first support roll
302 second support roll
303 separator film
401 calender roll
500 machine frame
520 bore
613 electrode film
700 roll bearing
904 powder hopper
905 powdered electrode precursor material
D1 roll diameter
D2 support roll diameter
F force vector
X deflection direction

1. A calender for producing an electrode film from a powder-type electrode precursor material,
comprising at least one first and one second nip roller, rotating in the opposite direction to the first, between which a nip is formed, wherein the calender is designed to apply shear forces to the powder-type electrode precursor material when the latter is passed through the nip and to thereby form an electrode film,
characterized in that at least one of the first or second nip rollers has at least one pretensioning device for pretensioning the nip roller against a non-axial, in particular radial and/or tangential, force vector (F) which is generated in the nip by the compression process and which acts on the respective nip roll, and by means of which the pretensioning direction and/or the magnitude of the pretensioning force is adjustable.

2. The calender according to claim 1, wherein both nip rollers are each mounted in a machine frame via their front roller journals, wherein the pretensioning device is assigned to at least one bearing of the first or the second nip roller, wherein by means of the pretensioning device the roller journal can be deflected radially in any direction and in an adjustable order of magnitude in relation to the at least one bearing.

3. The calender according to claim 1, wherein the pretensioning device has a double eccentric, wherein the double eccentric has an inner eccentric bushing and an outer eccentric bushing, which are rotatable independently of one another.

4. The calender according to claim 3, wherein the first or the second nip roller is rotatably mounted in the inner eccentric bushing.

5. The calender according to claim 3, wherein the outer eccentric bushing is rotatably mounted relative to a bore arranged in the machine frame, in which the pretensioning device is received.

6. The calender according to claim 5, wherein a first radial bearing is formed or arranged between the bore and the outer eccentric bushing.

7. The calender according to claim 3, wherein a second radial bearing is formed or arranged between the outer eccentric bushing and the inner eccentric bushing.

8. The calender according to claim 3, wherein a third radial bearing is formed or arranged between the inner eccentric bushing and the roller journal.

9. The calender according to claim 6, wherein the first and/or the second and/or the third radial bearing is designed as a cylindrical roller bearing or as a needle bearing.

10. The calender according to claim 1, wherein a first support roller is arranged adjacent to the first nip roller and a second support roller is arranged adjacent to the second nip roller, which each rotate in the opposite direction to the latter.

11. The calender according to claim 10, wherein the support rollers have a larger diameter (D2) than the first and second nip rollers.

12. The calender according to claim 10, wherein the axes of the nip rollers and of the support rollers are aligned in a plane with one another.

13. The calender according to claim 10, wherein the first nip roller and the first support roller roller on one another and a nip for passage of the electrode film is formed between the second nip roller and the second support roller, wherein the second nip roller is designed to guide the electrode film around the upper or lower side of the second nip roller.

14. The calender according to claim 1, wherein a device for continuously conveying powder-type electrode precursor material into the roller nip is arranged above the roller nip between the first and second nip rollers.

15. The calender according to claim 1, wherein at least one of the first or second nip rollers has a pretensioning device on each of its opposite roller journals.

16. The calender according to claim 1, wherein both the first and the second nip rollers have a respective pretensioning device on each of their opposite roller journals.

17. A method for producing an electrode film having a homogeneous thickness from a powder-type electrode precursor material, comprising the following steps:
conveying powder-type electrode precursor material into a nip formed by two nip rollers;
passing the powder-type electrode precursor material through the nip, wherein the powder-type electrode precursor material is subjected to shear forces as it passes through the nip, so that an electrode film is formed;
applying a pre-tension to at least one of the two nip rollers in order to counteract a force vector (F) resulting from the passing of the powder-type electrode precursor material through the nip on the respective nip roll.

18. The method according to claim 17, wherein the application of a pre-tension comprises the radial deflection of at least one roller journal of the respective nip roller.

19. The method according to claim 18, wherein the radial deflection of the at least one roller journal comprises the relative and/or uniform pivot of a double eccentric provided on the roller journal.

20. The method according to claim 18, wherein the radial deflection comprises the deflection of two opposite roller journals of at least one of the nip rollers, wherein both roller journals are deflected radially in the same direction.

21. The method according to claim 18, wherein the radial deflection comprises the deflection of two opposing roller journals of both nip rollers, wherein the opposing roller journals are each deflected in the same direction and the roller journals of the first and the second nip roller are deflected in the same or in the diametrically opposite direction.

22. The method according to claim 17, further comprising:
supporting of both nip rollers on the respective sides of the nip rollers facing away from the nip by means of a line force respectively acting radially on each of the nip rollers.

23. An electrode film which has a homogeneous thickness so that the thickness variation of the electrode film across its width is not more than 10 μm, obtainable by passing a powder-type electrode precursor material through a nip formed between a first and a second nip roller and in the course of which the powder-type electrode precursor material is subjected to shear forces so that an electrode film is formed, and by applying a pre-tension to at least one of the nip rollers in order to counteract a force vector (F) resulting from the passing of the powder-type electrode precursor material through the nip on the respective nip roller.

24. The electrode film according to claim 23, which is one or more of an anode film, a cathode film, a separator film, a current collector film, an interlayer film, an adhesive film, a primer film, or a laminate made up of several of the above-mentioned films.
